(19) United States
(12) Patent Application Publication
(10) Pub. No.: US 2018/0192127 A1
(43) Pub. Date: Jul. 5, 2018

(54) SYSTEM AND METHOD FOR DIGITAL TELEVISION OPERATION AND CONTROL - CONVERSENSE

(71) Applicants: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(72) Inventors: Sanjiv SIRPAL, Oakville (CA); Mohammed SELIM, Oakville (CA); Alexander DePaz, Burlington (CA); Salvador SOTO, Toronto (CA); Karina Amaral LIMONGI, Oakville (CA); Clara GHANDOUR, Mississauga (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/396,301

(22) Filed: Dec. 30, 2016

(51) Int. Cl. H04N 21/442; H04N 21/45; H04N 21/466; H04N 21/431

(52) U.S. Cl. CPC H04N 21/44222; H04N 21/4532; H04N 21/44204; H04N 21/4312; H04N 21/4668

(57) ABSTRACT

A digital television including: a display; a memory; and a processor coupled to the memory and the display, the processor configured to: track operation of the television by: identifying content and applications accessed using the television and a time of access that content is accessed for a user profile; store information corresponding to the identified content and time in connection with the user profile; receive a wake-up command; identify the user profile; analyze the stored information to identify recommended content sources of the television; display a collection of selectable elements corresponding to at least one of content and content source based on the recommended content sources, the selectable elements being presented within a control interface during initial operation of the display device; receive an indication of a selection of a selectable element from the collection of selectable elements; and control operation corresponding to the selected selectable element.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for control interfaces for applications and television components. In particular, there exists a need for programs and configurations that allow for features of the applications to be presented, accessed and customized on a digital television. While execution of an application and application interfaces exist for digital televisions, there exists a need for improved control of television features. Conventional interfaces do not contextualize a startup based on situational and user data. There is a desire for contextualized navigation and updating to improve functionality and usability of display devices.

### SUMMARY

Disclosed and claimed herein are methods, devices and systems for control of a digital television. One embodiment is directed to a digital television including: a display; a memory; and a processor coupled to the memory and the display. The processor may be configured to: track selections and operation of the television by: identifying content and applications accessed using the television associated with a user profile, and identifying a time of access that content is accessed using the television for the user profile; store information corresponding to the identified content and the identified time in connection with the user profile; receive a wake-up command; identify, in response to the wake-up command, the user profile; analyze the information stored in connection with the user profile to identify recommended content sources of the television; display a collection of selectable elements corresponding to at least one of content and content source based on the recommended content sources, the selectable elements being presented within a control interface during initial operation of the display device; receive an indication of a selection of a selectable element from the collection of selectable elements; and control operation corresponding to the selected selectable element.

The presentation of the control interface may include presentation of an avatar image, a personalized message, and the control interface as an overlay to displayed content.

The recommended content sources may be identified based on a current time and past access during similar time periods.

The recommended content sources may be identified based on a current day and a current time of day.

The processor may be further configured to: repeatedly track user behavior of the television for the user profile; and update the stored information based on the repeated tracking.

The processor may be further configured to: receive information on currently available content; and compare the currently available content to an expected usage of the digital television. The collection of graphical elements may include graphical elements corresponding to a subset of the currently available content.

The collection of graphical elements may include one or more of: a content icon corresponding to content recommended to be watched for a user; an application icon corresponding to an application recommended to be used by the user; a game icon corresponding to a game recommended to be played by the user; and an information icon corresponding to information recommended to be accessed by the user.

The processor may be further configured to: generate contextual information indicating a basis for identifying respective graphical elements of the collection of graphical elements; and display the contextual information proximate to the respective graphical element.

The processor may be further configured to: display the control interface for period of time based on the user profile; and output, in response to an expiration of the period of time without reception of the indication of the selection, a most recent usage of the television and cease displaying the control interface.

The processor may be configured to analyze the stored information by: comparing the time of access to a current time; and identifying content sources providing content corresponding to a user behavior at a similar time as the current time as the recommended content sources.

According to some embodiments, there is provided a method for controlling display device operation, the method including: tracking selections and operation of the television by: identifying content and applications accessed using the television associated with a user profile, and identifying a time of access that content is accessed using the television for the user profile; storing information corresponding to the identified content and the identified time in connection with the user profile; receiving a wake-up command; identifying, in response to the wake-up command, the user profile; analyzing the information stored in connection with the user profile to identify recommended content sources of the television; displaying a collection of selectable elements corresponding to at least one of content and content source based on the recommended content sources, the selectable elements being presented within a control interface during initial operation of the display device; receiving an indication of a selection of a selectable element from the collection of selectable elements; and controlling operation corresponding to the selected selectable element.

The method may further include repeatedly tracking user behavior of the television for the user profile; and updating the stored information based on the repeated tracking.

The method may further include: receiving information on currently available content; and comparing the currently available content to an expected usage of the digital television. The collection of graphical elements may include graphical elements corresponding to a subset of the currently available content.

The method may further include: generating contextual information indicating a basis for identifying respective graphical elements of the collection of graphical elements; and displaying the contextual information proximate to the respective graphical element.

The method may further include: displaying the control interface for period of time based on the user profile; and outputting, in response to an expiration of the period of time without reception of the indication of the selection, a most recent usage of the television and cease displaying the control interface.

The analyzing the stored information may include: comparing the time of access to a current time; and identifying content sources providing content corresponding to a user behavior at a similar time as the current time as the recommended content sources.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a control interface of a display device according to one or more embodiments.

FIG. 2 depicts a simplified system diagram according to one or more embodiments.

FIG. 3 is a flowchart illustrating a method of controlling a display device according to an example embodiment.

FIG. 4 is a flowchart illustrating tracking an operation of a display device according to an example embodiment.

FIG. 5 is a flowchart illustrating updating information according to an example embodiment.

FIG. 6 is a flowchart illustrating a method of controlling a display device according to an example embodiment.

FIG. 7 illustrates a control interface according to an example embodiment.

FIG. 8 is a representation of stored data according to an example embodiment.

FIG. 9 is a block diagram of an illustrative computer system architecture according to an example implementation.

FIG. 10 illustrates a flow diagram of an operation of a display device according to an example embodiment.

FIG. 11 illustrates a flow diagram of an operation of a display device according to an example embodiment.

### DETAILED DESCRIPTION OF THE EXAMPLE EMBODIMENTS

One aspect of the disclosure relates to providing a control interface for a digital television. In one embodiment, a system and framework are provided for presentation of a control interface. The digital television may monitor use of the television. Upon being powered on or in response to a wake-up command, the digital television may identify a user and present the control interface including selectable elements that correspond to recommended content for the user. When an element is selected, the digital television may operate in accordance with the selected element.

Example implementations of the disclosed technology will now be described with reference to the accompanying figures.

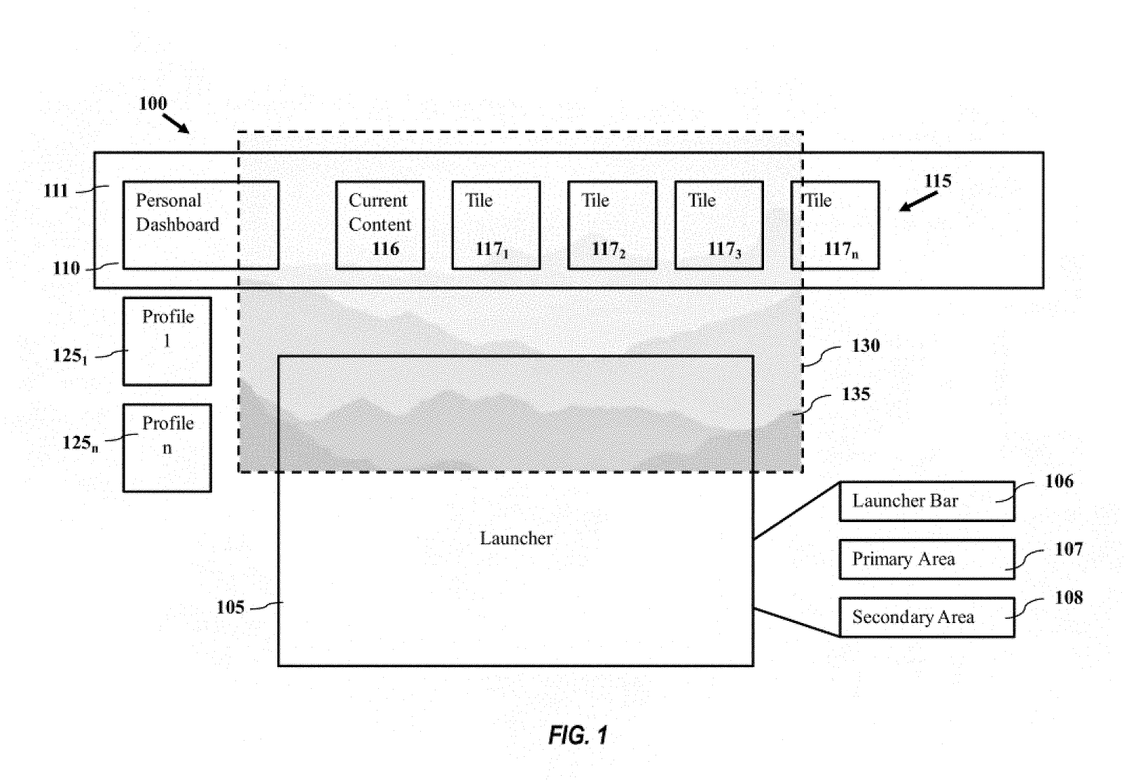

Referring now to the figures, FIG. 1 depicts a graphical representation of a control interface of a display device according to one or more embodiments. According to one embodiment, control interface 100 relates to a graphical user interface presented to control a display device, such as a digital television. According to one aspect of the disclosure, control interface 100 includes a plurality of components that each provide a plurality of functions and features for control and operation of a display device. In addition to providing separate components for particular interaction, control interface may also be configured to operate with a specific arrangement. According to one embodiment, presentation of each component of control interface 100 is presented based on a spatial arrangement model. According to one embodiment, the spatial arrangement model defines a relative position of components of control interface 100 to allow for directional navigation of the interface. By employing a spatial arrangement model, components of the control interface 100 allow for many features of the display device to be easily accessed and controlled. In addition to facilitating access, the spatial arrangement model provides a specific formatting to each view of control interface to emphasize elements for control.

According to one embodiment, components of control interface 100 include launcher component 105, dashboard component (e.g., personal dashboard) 110 and activity strip 115. According to another embodiment, a spatial arrangement model defines the location of each component of control interface 100 relative to a display screen. In an exemplary embodiment, launcher component 105 is oriented relative to a bottom portion of the display, dashboard component (e.g., personal dashboard) 110 is oriented relative to a left side of the display, and activity strip 115 is oriented relative a right side of the display. According to another embodiment, the display format of each component is defined by the spatial arrangement model such that each component may have an initial presentation characterized by a particular format, size, functionalities displayed, etc. Based on navigation commands relative to the control interface, the display device may update and rearrange the position and display format for each component of control interface 100.

Control interface 100 is shown in FIG. 1 relative to a display 130 and display content 135. According to one embodiment, the display format of control interface 100 can include presentation of some or all components of the control interface on display 130. Based on commands detected during presentation of the control interface 100, a display device may update the presentation format and elements of control interface 100 on display 130.

According to one embodiment, control interface 100 provides a mechanism for accessing multiple components of a display device. While the description of FIG. 1 discusses three components of control interface 100 (launcher component 105, dashboard component 110 and activity strip 115), it should be appreciated that additional components may be added to or included with control interface 100. As will be discussed herein, control interface 120 may be employed to control operation of digital television.

Activity bar includes plurality of tile elements 116 and 117₁₋ₙ. According to one embodiment, presentation of control interface 100 may be presented as an overlay to content 135 presented on display 130. The display device may freeze or continue presenting the display output of content 135 in a tile element 116 in activity bar 115. In certain embodiments, navigation away from current content tile 116 will pause or stop playback. Current content tile 116 allows for selection of the previously displayed content to return to presentation of the display. Current content tile 116 is presented based on the content displayed by the display device prior to display of control interface 100. Tile elements 117₁₋ₙ relate to activity feed based on current content. In one embodiment, tile elements 117₁₋ₙ relate to a single type of content, such as broadcast TV shows related current content 116 and/or based on viewing habits of an active profile. According to another embodiment, tile elements 117₁₋ₙ may be a mix of content types, such as broadcast content, video on demand, applications, etc. In one embodiment, a display device may curate content and features to be included with activity bar as tile elements 117₁₋ₙ and present activity bar as a horizontal deck of elements in horizontal region 111. Horizontal region 111 allows for left and right directional commands to navigate to and within components of control interface 110.

Profiles 125₁₋ₙ relate to one user profiles stored by a display device for control interface 100. In one embodiment, profiles 125₁₋ₙ are utilized to determining display format of the personal dashboard component 110. According to another embodiment, one or more elements of launcher component 105 and activity strip 115 may be presented base on an active profile of profiles 125₁₋ₙ. When a profile has not been selected, an active profile may be the last selected or utilized user profile.

According to another embodiment, components of control interface 100 may be selected, navigated and updated based on user interactions with a display device and one or more inputs from a remote control. According to one embodiment, elements of control interface 100 are presented by display device 130, such as digital television, as part of control interface 120.

Presentation of control interface 100 may be in response to a command from remote control, such as selection of a home or menu key. According to another embodiment, control interface 100 may be displayed shortly after a power on of display device 130. According to another embodiment control interface 100 may be presented following presentation of a wake animation and prior to display of a sleep or shutdown animation.

From control interface 100, several features and functions of a display device may be provided by ordered combinations of display device operation and graphical elements presented by the display device.

Launcher

According to one embodiment, launcher component 105 is configured to allow for a user to access content and control features of the display device. In one embodiment, launcher component includes a launcher bar 106, primary area 107 and secondary area 108. Launcher bar 106 may related to a plurality of tab elements arranged in a horizontal strip, wherein selection by moving a highlight element of the display device to a tab element will update the presentation elements of the launcher. By way of example, launcher bar 105 may include a tab for broadcast channels, video on demand and display device settings. Primary area 107 may include presentation of tile elements below the launcher bar 106. Tile elements of primary area 107 may be selected by the display device as the most relevant content of features associated with a selected tab element. Secondary area 108 may be presented below the primary area with additional tiles associated with content and/or display device function. Secondary area 108 may allow for additional selectable elements. According to one embodiment, the display format of launcher bar 106, primary area 107, and secondary area 108 may be based on the presentation status of the control interface. For example, launcher component may be presented initially with launcher bar 106, then commands to expand launcher component (e.g., a directional command) can result in display device updating the display output to include one or more tile elements of the primary area. Tile elements of the secondary area 108 may be presented based on additional navigation within the launcher component.

According to one embodiment, an initial format, such as a home screen presentation, of control interface 100 includes presentation of launcher bar, and a row of tile elements of the primary area. Based on a user input to select and/or navigate within launcher component 105, additional formats may be presented such as an increase in presentation footprint of the launcher to allow for secondary area 108 to include additional rows of tile elements. According to another embodiment, the primary area 107 and secondary area 108 of launcher component 105 may also include a first section for presentation of a most relevant tile element, and a second section for presentation of other tile elements along a horizontal display plane.

According to one embodiment, control interface 100 provides launcher component 105 as an overlay control interface to allow for presentation of content and control features based on selection of launcher tabs and navigation within the launcher component. In one embodiment, the configuration of launcher component 105 is a progression away from traditional desktop menus and allows for simple directional commands to access TV, network, applications, recommendations, personalized configurations, and recent content. According to another embodiment, launcher bar 106 of launcher component 105 includes a plurality of tab or tile elements, wherein each tab allows for a selection of a particular type of content, source of content, and/or control features of a display device. Based on the selection of a tab element of launch bar 106, launcher component may present multiple rows of content/element tiles and allows for scrolling to additional rows within a display window to provide and extended content region. In one embodiment, each row of content tiles may be navigated to based on vertical directional commands (e.g., up/down) and rows of content tiles may be navigated with horizontal directional commands (e.g., left/right). The presentation order of rows and even tiles in each row may be based on one or more of a selected user profile, content presented prior to display of control interface 100 and relevance determinations. In additional to content, such as video and programming information, tiles presented in launcher component 105 may relate to one or more of applications, settings, smart home applications, education/learning applications, gaming, etc.

Launcher Search

According to one embodiment, control interface 100 may include a search functionality component including a graphical interface for searching content titles, applications and elements of launcher component 105. In one embodiment, the search functionality may be presented as a drop down (e.g., down sliding transition) interface from an intermediary presentation format of control interface 100. According to another embodiment, the search functionality can interact with other devices (e.g., mobile devices) with a display device hosting a network interface for entry of search queries. Features of the search functionality can include one or more of a text entry box, alpha numeric display, recent search listing and suggested search results.

Personal Dashboard

According to one embodiment, control interface 100 includes dashboard component 110 to provide a user customizable control interface for a portion of the control features. In one embodiment, dashboard component 110 provides graphical elements for selecting and modifying display attributes and functionality of the dashboard. According to another embodiment, dashboard component can allow for a graphical selection of user profiles that can define features of control interface 100.

According to one embodiment, personal dashboard component 110 allows for presentation of a personalized control interface associated with a user profile. By way of example, display device is configured to allow a user to personalize the display format of the user interface to select display attributes such as a wallpaper, avatar, etc. In that fashion, dashboard component 110 allows for presentation of a personalized control interface. According to one embodiment, control interface 100 can allow for presentation of several user profiles 125₁₋ₙ. Selection of the profile may be performed during navigation to personal dashboard component 110 within control interface 100. According to one embodiment, the initial display presentation format of personal dashboard component 110 relates to a tile element, such as a screen capture of the personal dashboard. When an intermediate display configuration of control interface 100 is provided, the same tile representing personal dashboard component 110 may be reformatted. According to one embodiment, personal dashboard component 110 may be displayed adjacent to activity bar 115 in a horizontal region 111 of the display.

In one embodiment, dashboard component 110 provides a display interface to include notifications and access to applications which may be run by a display device. According to another embodiment, dashboard component 110 allows for personalization such as one or more of wake/sleep animations, screensavers, audio themes, badges and gaming. Dashboard component 110 allows for a customizable interface within the overall control interface 100 of a display device.

Touch Interface

Presentation of elements within control interface can include one or more display formats and format changes. In certain embodiments, presentation of elements introduces similarities of touch commands to a display device operated from a distance without actual contact to the display. According to one embodiment, control interface 100 can update presentation of display elements such as tiles to gradually reveal content. According to one embodiment, control interface 100 can receive inputs based on a capacitive touch sensor with gradual display of elements, but also allowing for accidental touches. Capacitive interaction can provide a control feature with a level of touch control for a display device that is normally operated/viewed from a distance. Control interface 100 may be configured with an interaction to model tactile representation for interaction with elements based on a capacitive/interactive remote control. In one embodiment, interaction may include progressive disclosure of content, a multilayered preview into content and instant access to recommendation.

Contextual Touch

According to one embodiment, elements of control interface 100 can support presentation of tile elements as overlay to content without presentation of the full control interface. By way of example, a display device may be configured to recognize a category or genre of actively displayed content and present a display of similar programs to avoid the need to access a display menu and searching of content.

Instant Companion Application and Search

According to one embodiment, control interface 100 can allow for control of a display device by a mobile device and to allow for presentation of graphical display elements of control interface 100 to be displayed by a mobile device. In one embodiment, control interface 100 may host temporary access between a display device and another web enabled device. According to another embodiment, devices may be paired based on displayed elements that may be detected by the web enabled device. Thus, control interface 100 may be configured for pairing/connection with a user interface, such as a personalized user dashboard for display devices and search functions within the launcher control interface. According to certain embodiments, interaction of a mobile device with control 100 does not require a user to download a specific application to establishing the temporary network connection for interaction and control of a display device.

Smart Sense Recommendations

According to one embodiment, control interface 100 can utilize one or more processes for populating content elements within launcher component 105. According to one embodiment, control interface 100 may be presented based on processes for tracking and identifying content for recommendation within the launcher component. For example, content tiles may be arranged in groupings such that groupings with the highest contextual relevance priority are arranged towards the top of launcher component 105.

Conversense

According to one embodiment, control interface 100 and elements of control interface 100 can be utilized by a display device to present a display configured tailored to startup of the display device with information and display elements having high relevance. In one embodiment, elements of the startup display may be selected and presented based on a recognized time of day, personal settings and history.

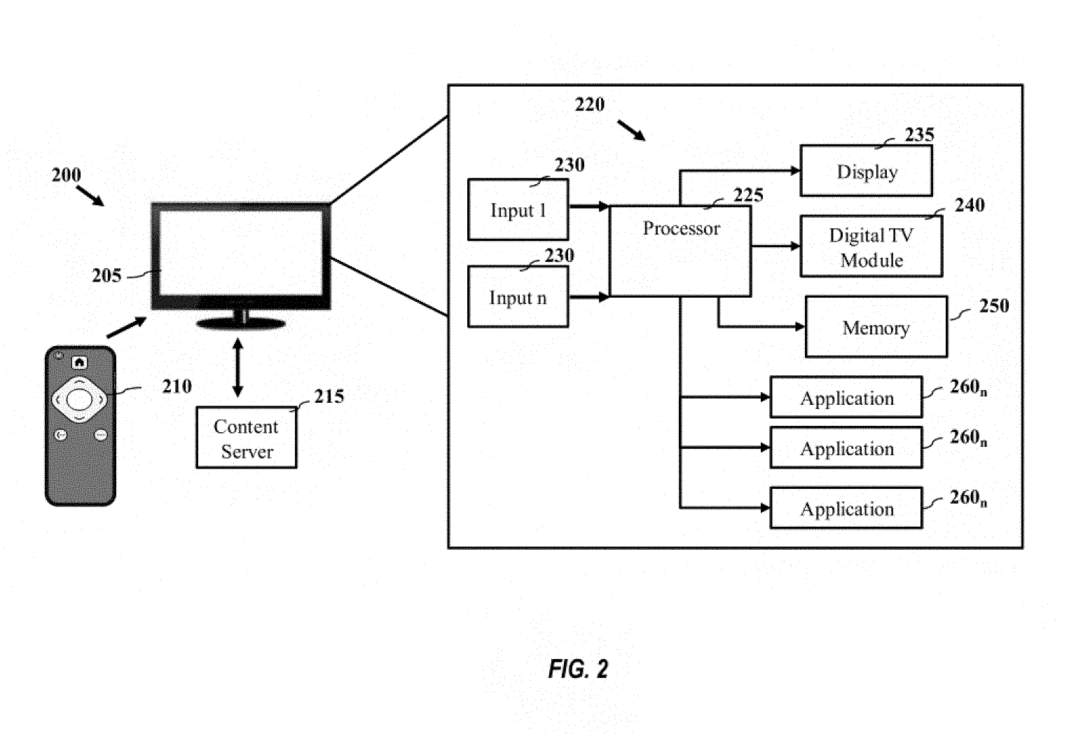

FIG. 2 depicts a simplified system diagram according to one or more embodiments. System 200 includes display device 205 and remote control 210. Remote control 210 may be configured to provide commands for interaction with and control of display device 205 relative to a control interface (e.g., control interface 100) presented by display device 205. Content, applications and other network services may be provided to display device 205 by way of one or more content servers, such as content server 215.

Digital television 200 includes processor 225, inputs 230, display 235, digital TV module 240, memory 250, and applications 260₁₋ₙ. It should be appreciated that digital television 205 may include one or more additional components not shown in FIG. 2. Digital television 205 is configured to present a control interface as described herein.

Inputs 230 relate to physical inputs for receiving video/image content and/or network data for presentation of content on display 235. Digital TV module 240 includes decoder/converter elements to receive information and content from inputs 230 which is then formatted and output to processor 225 for presentation on display 235. Memory 250 may include ROM and RAM memory for operation of digital television 205 and processor 225.

Processor 225, in addition to controlling operation of a digital television, is configured to control presentation and operation of a control interface. According to one embodiment, processor 225 is configured to detect commands for presentation of a control interface for the digital television, present the control interface including an expanded tab element and a plurality of tab elements. Processor 225 may also detect second or additional commands for the control interface to select one of the plurality of tab elements and update presentation of the control interface in response to the commands.

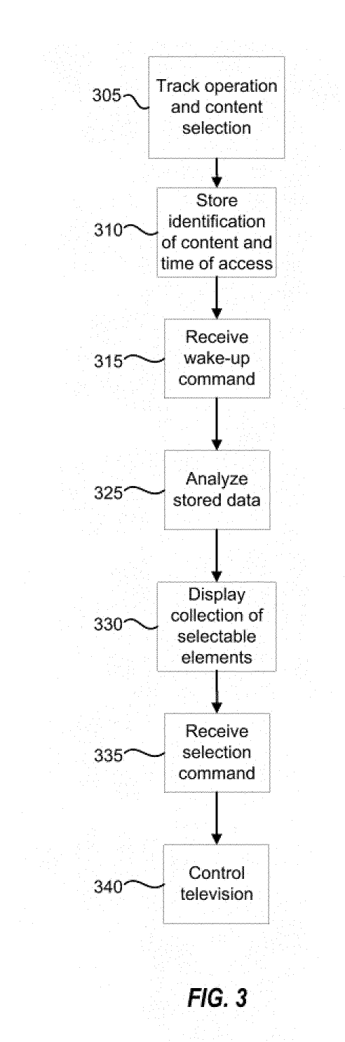

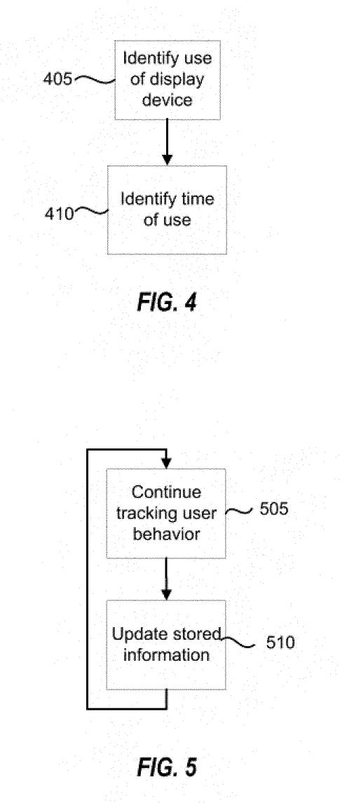

FIG. 3 is a flowchart illustrating a method of controlling a display device according to an example embodiment. The method may be performed by a display device, e.g. a digital television. In some embodiments, the method may be performed by a set top box in connection with a display. Referring to FIG. 3, a display device tracks an operation of the display device, and content selection on the display device at block 305. For example, the display device may track what content is selected to be presented by the display device. An example embodiment of the tracking at block 305 is illustrated in FIG. 4.

At block 310 the display device may store an identification of the content and an access time of the content in a memory. For example, the identification and access time may be stored in a memory of the display device or transmitted to an external storage device, such as a server. The content may be stored in association with a user profile.

At a later time, the display device receives a wake-up command at block 315. For example, the display device may have been in a low-power or power off state and receive a wake-up command from a remote control through a receiver at block 315. In other cases, the display device may receive an internal wake-up command based on a current time at block 315. The display device may identify a user profile and analyze stored information associated with the user profile at block 325. The display device may analyze the stored information to identify recommended content or content sources, such as television shows, applications, or games.

The display device may display a collection of selectable elements that correspond to content and applications based on the recommended content sources at block 330. The collection of selectable contents may be displayed in control interface during initial operation of the display device, e.g., in response to the wake-up command.

The display device may receive a selection command indicating a selection of one of the selectable elements from the collection of selectable elements at block 335. For example, the selection command may be received through a user interface, such as a remote control or through a voice command. At block 340 the display device then controls an operation corresponding to the selected element. For example, if the selected element corresponds to a televisions show, the display device may output the television show. As another example, if the selected element corresponds to an application, the display device may initiate the application.

Referring to FIG. 4, the tracking at block 305 may include identifying a use of the display device at block 405. For example, the display device may identify whether the display device is used for watching television, playing a game, or accessing an app, along with a name of the content accessed. The tracking at block 305 may further include identifying a time of the identified use at block 410. The time may include a time of day, a day of the week, and a length of time of use. According to some examples, the time may indicate whether the use occurred on a holiday or a particular holiday.

FIG. 5 depicts a process performed by the display device to continuously or repeatedly track, at block 505, use of the display device in relation to a user. At block 510, the display device may update the stored information based on information gathered from the tracking.

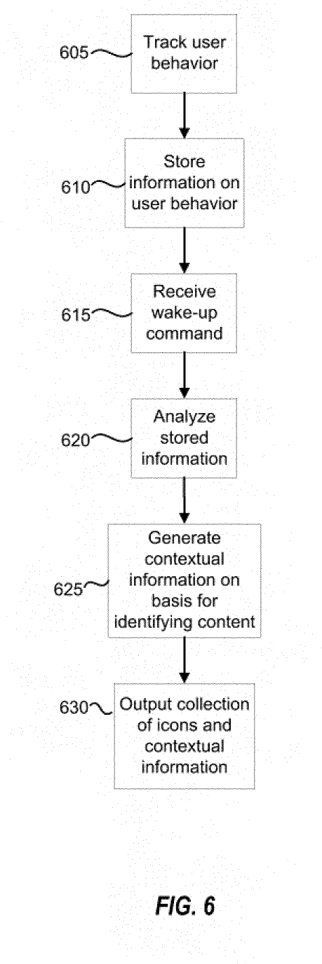

FIG. 6 is a flowchart illustrating a method of controlling a display device according to an example embodiment. The method may be performed by a display device, e.g. a digital television. In some embodiments, the method may be performed by a set top box in connection with a display. Referring to FIG. 6, a display device tracks an operation of the display device, and content selection on the display device at block 605. The tracking at block 605 may be similar to the tracking at block 305 discuss above with reference to FIG. 3.

At block 610, the display device stores information corresponding to user behavior on the display device. For example, the display device may store information about routine or predicted use of the display device, such as a time of day a user typically accesses particular content on the display device.

Later, the display device may receive a wake-up command at block 615. For example, the display device may have been in a low-power or power off state and receive a wake-up command from a remote control through a receiver at block 615. In other cases, the display device may receive an internal wake-up command based on a current time at block 615.

The display device analyzes the stored information at block 620. For example, the display device may compare a current day and time with the information about the user behavior to determine content to be presented to a user. In some cases, the display device may identify content based on routine use of the display device. At block 625 the display device generates contextual information on the bases for identifying the content. The display device then outputs a collection of icons or graphical elements together with the contextual information at block 630. The collection of icons and contextual information may be output as part of a control interface during initial operation of the display device, e.g., in response to the wake-up command.

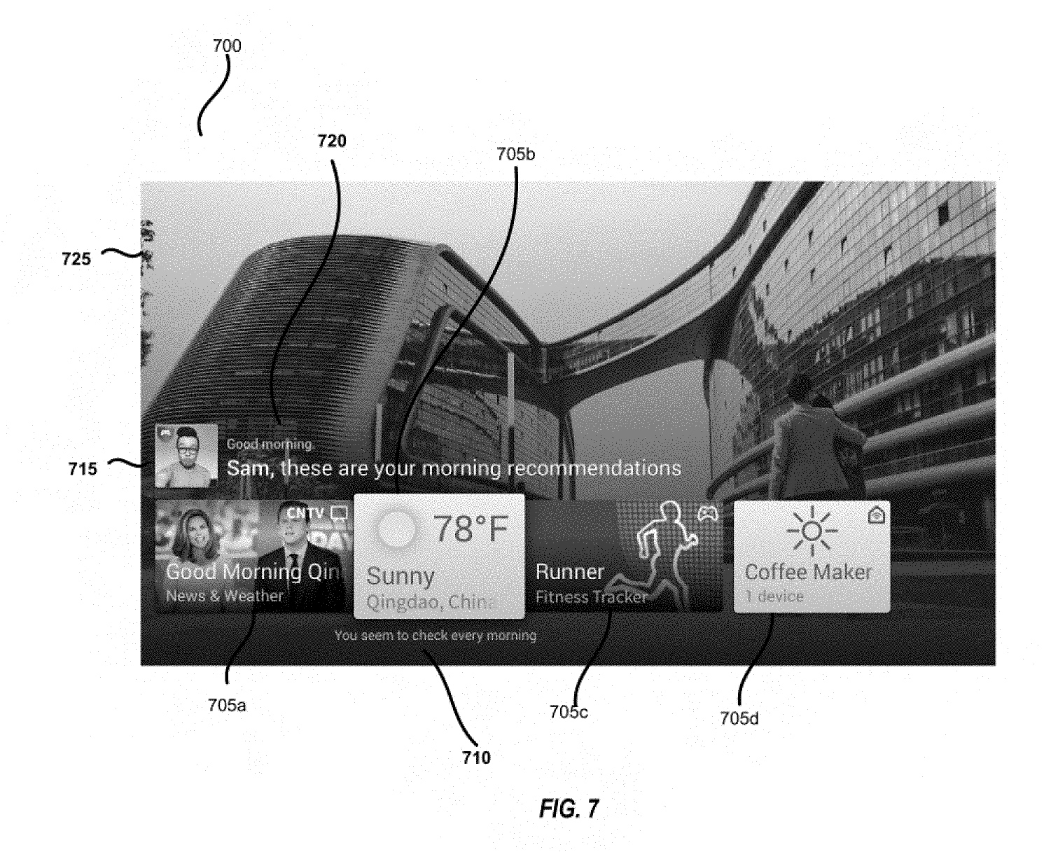

FIG. 7 illustrates a control interface 700 according to an example embodiment. The control interface 700 may be presented in response to receiving a wake-up command. The control interface 700 may include a plurality of graphical elements 705a-705d, e.g., icons or selectable elements, contextual information 710 corresponding to one or more of the plurality of graphical elements 705a-705d, an avatar image 715, and a personalized message 720. In some cases, the control interface 700 may be overlaid on content displayed by the display device. The content displayed by the display device upon wake-up may correspond to a content displayed when the display device was placed in the low-power or no-power state.

The graphical elements 705a-705d may correspond to respective content or applications and may be selected by the display device based on a user of the display device. The display device may monitor user selection of content and operation of the display device and analyze this data to select the graphical elements 705a-705d. In some cases, the selection of the graphical elements 705a-705d is limited by content that is available at a time of receiving the wake-up command. In some cases, the graphical elements may include to one or more of a content icon 705a content expected to be watched by the user, an information icon 705b corresponding to information expected to be desired by the user, a game icon 705c corresponding to a game expected to be played by the user, and an application icon 705d corresponding to an application expected to be used by the user.

The personalized message 710 may indicate a reason for why a particular graphical element 705a-705d. For example, if a user checks the weather every morning, if the display device receives a wake-up command around 8:00 AM, an information icon 705b corresponding to the weather may be selected and presented. The personalized message 710 may indicate that the user typically checks the weather in the morning. As another example, if a user typically watches a show during its air-time, a content icon 705a corresponding to the show may be presented if the display device is woken up around the show's air time. The personalized message 710 may state that the user typically watches the show every week.

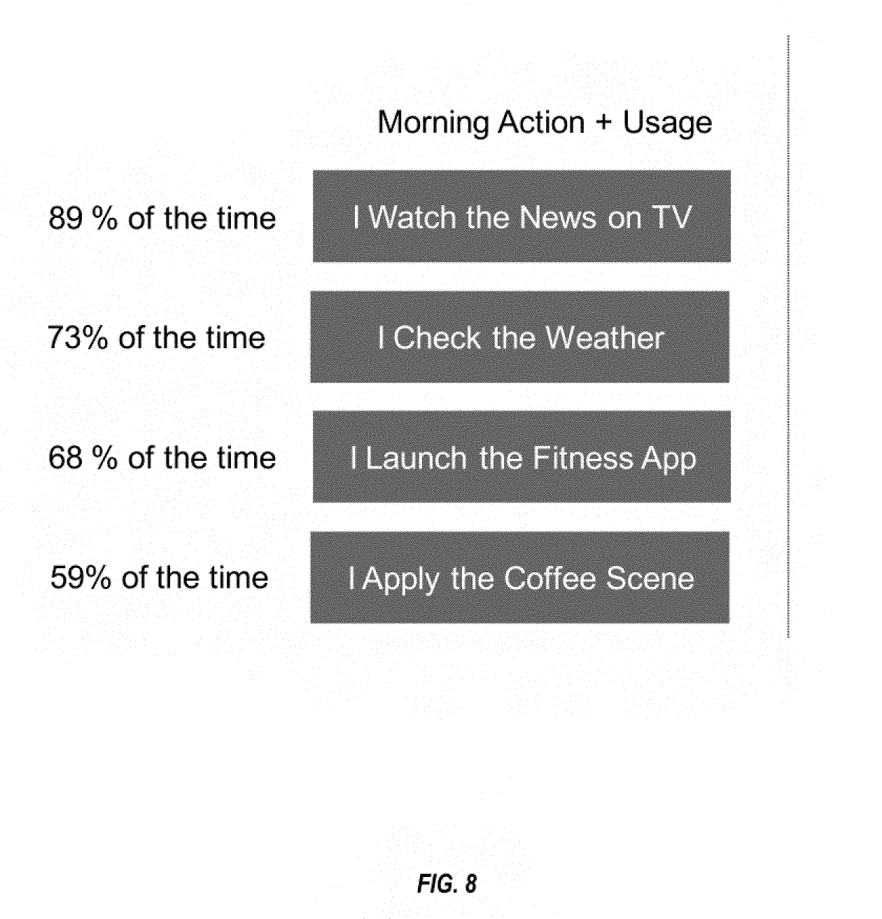

FIG. 8 illustrates a representation of data that the display device may use to select graphical elements 705a-705d. The data may be analyzed based on, for example, time of day and day of week. As an example, the data may indicate typically usages of the display device during a morning. The display device may collect and reference this data to select the graphical elements 705a-705d corresponding to expected usage of the display device.

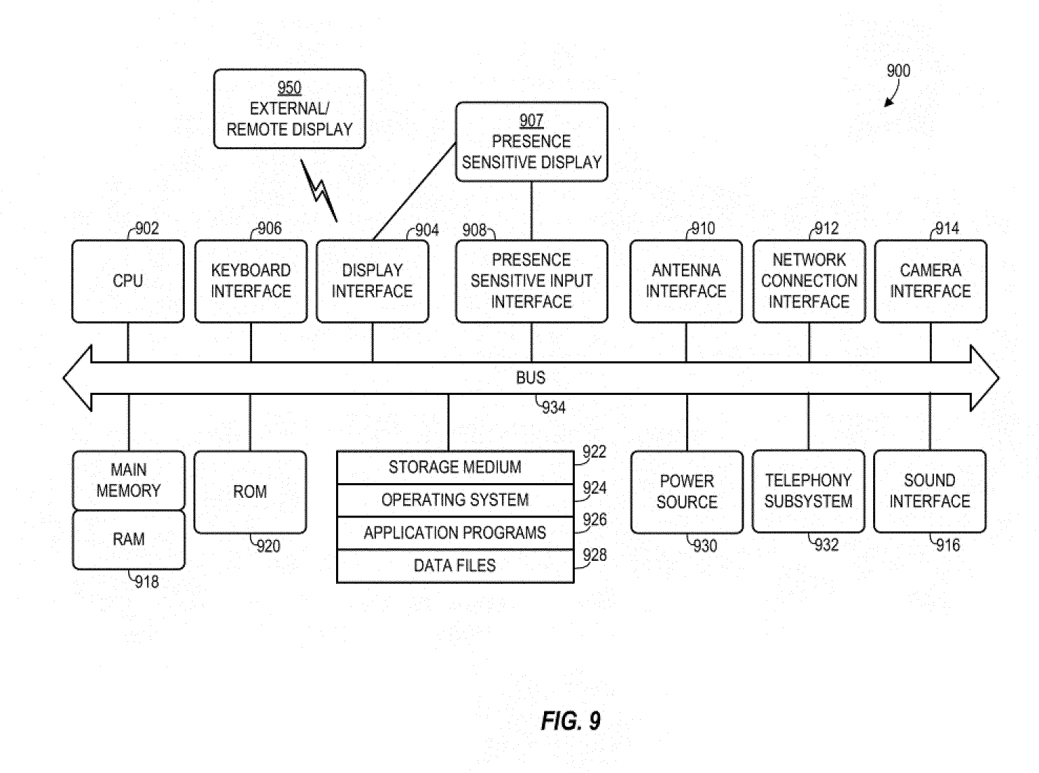

FIG. 9 is a block diagram of an illustrative computer system architecture 900, according to an example implementation. According to some embodiments, a display device may be implemented using one or more elements from the computer system architecture 900. It will be understood that the computing device architecture 900 is provided for example purposes only and does not limit the scope of the various implementations of the present disclosed systems, methods, and computer-readable mediums.

The computing device architecture 900 of FIG. 9 includes a central processing unit (CPU) 902, where computer instructions are processed, and a display interface 904 that acts as a communication interface and provides functions for rendering video, graphics, images, and texts on the display. In certain example implementations of the disclosed technology, the display interface 904 may be directly connected to a local display, such as a touch-screen display associated with a mobile computing device. In another example implementation, the display interface 904 may be configured for providing data, images, and other information for an external/remote display 950 that is not necessarily physically connected to the mobile computing device. For example, a desktop monitor may be used for mirroring graphics and other information that is presented on a mobile computing device. In certain example implementations, the display interface 904 may wirelessly communicate, for example, via a Wi-Fi channel or other available network connection interface 912 to the external/remote display 950.

In an example implementation, the network connection interface 912 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 904 may be operatively coupled to a local display, such as a touch-screen display associated with a mobile device. In another example, the display interface 904 may be configured to provide video, graphics, images, text, other information, or any combination thereof for an external/remote display 950 that is not necessarily connected to the mobile computing device. In one example, a desktop monitor may be used for mirroring or extending graphical information that may be presented on a mobile device. In another example, the display interface 904 may wirelessly communicate, for example, via the network connection interface 912 such as a Wi-Fi transceiver to the external/remote display 950.

The computing device architecture 900 may include a keyboard interface 906 that provides a communication interface to a keyboard. In one example implementation, the computing device architecture 900 may include a presence-sensitive display interface 908 for connecting to a presence-sensitive display 907. According to certain example implementations of the disclosed technology, the presence-sensitive display interface 908 may provide a communication interface to various devices such as a pointing device, a touch screen, a depth camera, etc. which may or may not be associated with a display.

The computing device architecture 900 may be configured to use an input device via one or more of input/output interfaces (for example, the keyboard interface 906, the display interface 904, the presence sensitive display interface 908, network connection interface 912, camera interface 914, sound interface 916, etc.) to allow a user to capture information into the computing device architecture 900. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 900 or may be a separate device. For example, the input device may be an accelerometer, a magnetometer, a digital camera, a microphone, and an optical sensor.

Example implementations of the computing device architecture 900 may include an antenna interface 910 that provides a communication interface to an antenna; a network connection interface 912 that provides a communication interface to a network. As mentioned above, the display interface 904 may be in communication with the network connection interface 912, for example, to provide information for display on a remote display that is not directly connected or attached to the system. In certain implementations, a camera interface 914 is provided that acts as a communication interface and provides functions for capturing digital images from a camera. In certain implementations, a sound interface 916 is provided as a communication interface for converting sound into electrical signals using a microphone and for converting electrical signals into sound using a speaker. According to example implementations, a random access memory (RAM) 918 is provided, where computer instructions and data may be stored in a volatile memory device for processing by the CPU 902.

According to an example implementation, the computing device architecture 900 includes a read-only memory (ROM) 920 where invariant low-level system code or data for basic system functions such as basic input and output (I/O), startup, or reception of keystrokes from a keyboard are stored in a non-volatile memory device. According to an example implementation, the computing device architecture 900 includes a storage medium 922 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 924, application programs 926 (including, for example, a web browser application, a widget or gadget engine, and or other applications, as necessary) and data files 928 are stored. According to an example implementation, the computing device architecture 900 includes a power source 930 that provides an appropriate alternating current (AC) or direct current (DC) to power components.

According to an example implementation, the computing device architecture 900 includes a telephony subsystem 932 that allows the device 900 to transmit and receive sound over a telephone network. The constituent devices and the CPU 902 communicate with each other over a bus 934.

According to an example implementation, the CPU 902 has appropriate structure to be a computer processor. In one arrangement, the CPU 902 may include more than one processing unit. The RAM 918 interfaces with the computer bus 934 to provide quick RAM storage to the CPU 902 during the execution of software programs such as the operating system application programs, and device drivers. More specifically, the CPU 902 loads computer-executable process steps from the storage medium 922 or other media into a field of the RAM 918 in order to execute software programs. Data may be stored in the RAM 918, where the data may be accessed by the computer CPU 902 during execution.

The storage medium 922 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 922, which may include a machine-readable storage medium.

According to one example implementation, the term computing device, as used herein, may be a CPU, or conceptualized as a CPU (for example, the CPU 902 of FIG. 9). In this example implementation, the computing device (CPU) may be coupled, connected, and/or in communication with one or more peripheral devices, such as a display. In another example implementation, the term computing device, as used herein, may refer to a mobile computing device such as a Smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device or a display device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, the computer program code may control the computing device to implement a control method as discussed herein.

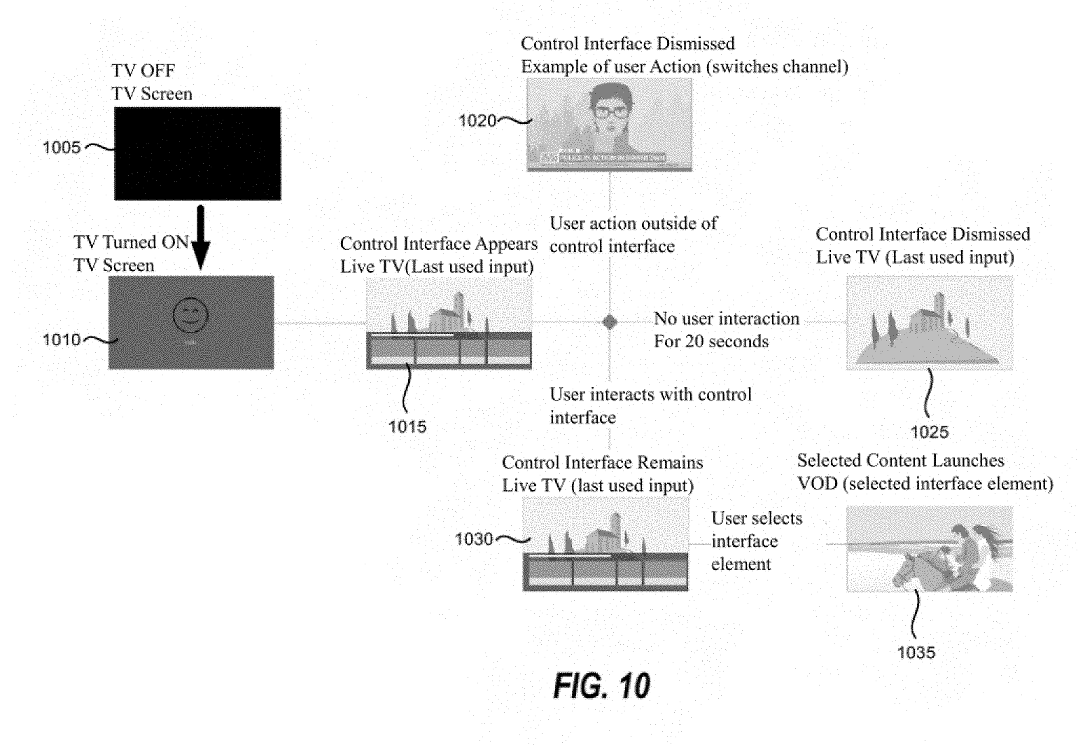

FIG. 10 illustrates a flow diagram of an operation of a display device according to an example embodiment. Referring to FIG. 10, the display device, e.g., a television, is initially in an off-state 1005. The off-state may be a low-power mode, e.g., a standby mode, or a no-power mode, e.g., a hibernating mode or a true off mode. The display device receives a turn-on command, e.g., a wake command, and presents an initial screen 1010. The display device may then present a control interface, as discussed above with reference to FIGS. 3-7, overlapping a most recent content 1015.

While the control interface is displayed 1015, a user may perform an action without using the control interface. For example, the user may issue change channel or change input commands through a remote control without selecting a graphical element of the control interface. In such case, the display device may dismiss the control interface and display content selected by the user excluding the control interface 1020.

While the control interface is displayed 1015, no user interaction may be received. After no user interaction is received for a predetermined time, e.g., 20 second, the control interface may be dismissed, and the most recent content may be displayed 1025.

While the control interface is displayed 1015, a user may interact with the control interface. For example, the user may submit commands for navigating selectable graphic elements of the user interface. The control interface may remain while the user is interaction with the control interface 1030. If the user selects an element of the control interface, the selected content may be launched 1035. For example, the selected content may correspond to a television channel, video-on-demand (VOD) content, game content, information content, or an application content.

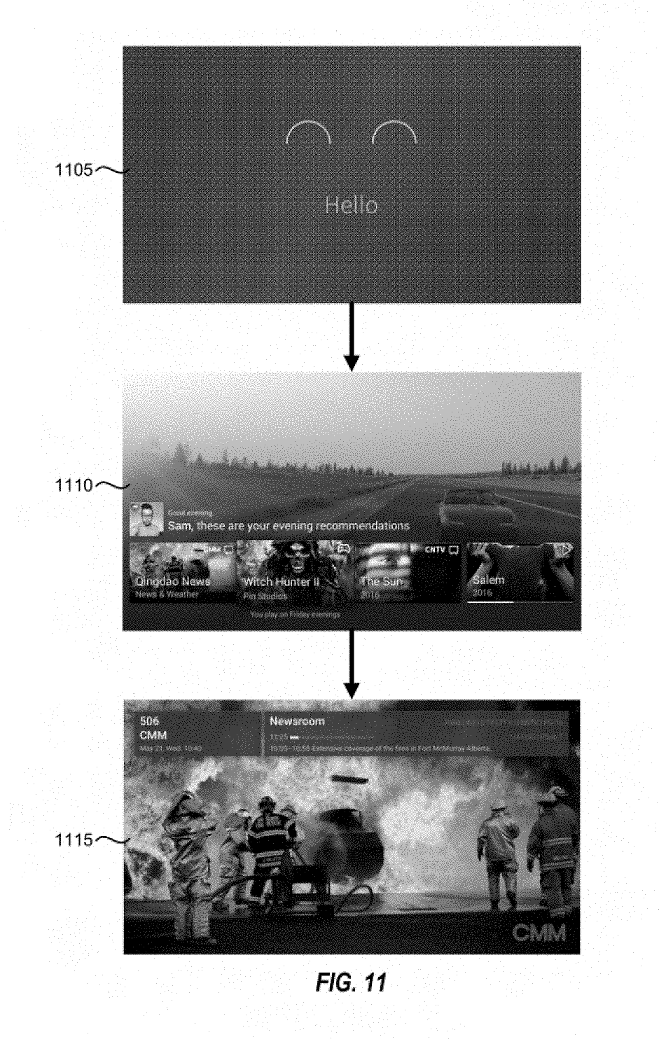

FIG. 11 illustrates a flow diagram of an operation of a display device according to an example embodiment. Referring to FIG. 10, the display device, e.g., a television, receives a wake-up command and presents a wake-up screen 1105. In some embodiments, the wake-up screen 1105 may be animated. The display device may output content from a most recent content source and overlay the content source with a control interface 1110. The control interface may include a plurality of graphical elements that may be navigated and selected by a user of the display device. In response to receiving a selection of one of the graphical elements, the display device may output content corresponding to the selected graphical element 1115.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims and their equivalents. Although specific terms are employed herein, they are used in a generic and descriptive sense only and not for purposes of limitation.

In the foregoing description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementation,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms should be construed to take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a -given sequence, either temporally, spatially, in ranking, or in any other manner.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims and their equivalents, and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

1. A digital television comprising:
a display;
a memory; and
a processor coupled to the memory and the display, the processor configured to:
track selections and operation of the television by:
identifying content and applications accessed using the television associated with a user profile, and
identifying a time of access that content is accessed using the television for the user profile;
store information corresponding to the identified content and the identified time in connection with the user profile;
receive a wake-up command;
identify, in response to the wake-up command, the user profile;
analyze the information stored in connection with the user profile to identify recommended content sources of the television and applications based on time of day;
display a collection of selectable elements including a graphical element associated for at least one identified content source based on the recommended content sources and a graphical element for at least one an application icon selected based on the user profile, the selectable elements being presented within a control interface during initial operation of the display device in response to the wake-up command, and wherein the recommended content sources are identified based on a current time and past access during similar time periods;
receive an indication of a selection of a selectable element from the collection of selectable elements; and
control operation corresponding to the selected selectable element.

2. The digital television of claim 1, wherein the presentation of the control interface includes presentation of an avatar image, a personalized message, and the control interface as an overlay to displayed content.

3. The digital television of claim 1, wherein the recommended content sources are displayed with a personalized message for at least one content source.

4. The digital television of claim 3, wherein the recommended content sources are identified based on a current day and a current time of day.

5. The digital television of claim 1, wherein the processor is further configured to:
repeatedly track user behavior of the television for the user profile; and
update the stored information based on the repeated tracking.

6. The digital television of claim 1, wherein
the processor is further configured to:
receive information on currently available content; and
compare the currently available content to an expected usage of the digital television, and
the collection of graphical elements includes graphical elements corresponding to a subset of the currently available content.

7. The digital television of claim 1, wherein the collection of graphical elements includes one or more of:
a content icon corresponding to content recommended to be watched for a user;
an application icon corresponding to an application recommended to be used by the user;
a game icon corresponding to a game recommended to be played by the user; and
an information icon corresponding to information recommended to be accessed by the user.

8. The digital television of claim 1, wherein the processor is further configured to:
generate contextual information indicating a basis for identifying respective graphical elements of the collection of graphical elements; and
display the contextual information proximate to the respective graphical element.

9. The digital television of claim 1, wherein the processor is further configured to:
display the control interface for period of time based on the user profile; and
output, in response to an expiration of the period of time without reception of the indication of the selection, a most recent usage of the television and cease displaying the control interface.

10. The digital television of claim 1, wherein the processor is configured to analyze the stored information by:
comparing the time of access to a current time; and
identifying content sources providing content corresponding to a user behavior at a similar time as the current time as the recommended content sources.

11. A method for controlling display device operation, the method comprising:
tracking selections and operation of the television by:
identifying content and applications accessed using the television associated with a user profile, and
identifying a time of access that content is accessed using the television for the user profile;
storing information corresponding to the identified content and the identified time in connection with the user profile;
receiving a wake-up command;
identifying, in response to the wake-up command, the user profile;
analyzing the information stored in connection with the user profile to identify recommended content sources of the television and applications based on time of day;
displaying a collection of selectable elements including a graphical element associated for at least one identified content source based on the recommended content sources and a graphical element for at least one an application icon selected based on the user profile, the selectable elements being presented within a control interface during initial operation of the display device in response to the wake-up command;
receiving an indication of a selection of a selectable element from the collection of selectable elements; and
controlling operation corresponding to the selected selectable element.

12. The method of claim 11, wherein the presentation of the control interface includes presentation of an avatar image, a personalized message, and the control interface as an overlay to displayed content.

13. The method of claim 11, wherein the recommended content sources are displayed with a personalized message for at least one content source.

14. The method of claim 13, wherein the recommended content sources are identified based on a current day and a current time of day.

15. The method of claim 11, further comprising:
repeatedly tracking user behavior of the television for the user profile; and
updating the stored information based on the repeated tracking.

16. The method of claim 11, further comprising:
receiving information on currently available content; and
comparing the currently available content to an expected usage of the digital television,
wherein the collection of graphical elements includes graphical elements corresponding to a subset of the currently available content.

17. The method of claim 11, wherein the collection of graphical elements includes one or more of:
a content icon corresponding to content recommended to be watched for a user;
an application icon corresponding to an application recommended to be used by the user;
a game icon corresponding to a game recommended to be played by the user; and
an information icon corresponding to information recommended to be accessed by the user.

18. The method of claim 11, further comprising:
generating contextual information indicating a basis for identifying respective graphical elements of the collection of graphical elements; and
displaying the contextual information proximate to the respective graphical element.

19. The method of claim 11, further comprising:
displaying the control interface for period of time based on the user profile; and
outputting, in response to an expiration of the period of time without reception of the indication of the selection, a most recent usage of the television and cease displaying the control interface.

20. The method of claim 11, wherein the analyzing the stored information includes:
comparing the time of access to a current time; and
identifying content sources providing content corresponding to a user behavior at a similar time as the current time as the recommended content sources.
